(19) United States
(12) Patent Application Publication
(10) Pub. No.: US 2022/0088869 A1
(43) Pub. Date: Mar. 24, 2022

(54) ADDITIVE MANUFACTURING SYSTEM HAVING ROTATING SUPPORT PLATFORM WITH INDIVIDUAL ROTATING BUILD BED

(71) Applicant: Nikon Corporation, Tokyo (JP)

(72) Inventor: Paul Derek Coon, Redwood City, CA (US)

(21) Appl. No.: 17/477,992

(22) Filed: Sep. 17, 2021

Related U.S. Application Data
(60) Provisional application No. 63/081,214, filed on Sep. 21, 2020.

(51) Int. Cl. B29C 64/245; B29C 64/241; B29C 64/264; B29C 64/232; B33Y 30/00

(52) U.S. Cl. CPC B29C 64/245; B29C 64/241; B29C 64/153; B29C 64/232; B33Y 30/00; B29C 64/264

(57) ABSTRACT

A processing machine (10) for building a three-dimensional object (11) from a material (12) includes a support platform (26A), a platform mover (30), a build bed (28), a bed mover (28C), and an energy system (22). The platform mover (30) moves the support platform (26A) in a platform rotation direction (30C) at a first angular velocity. The build bed (28) is movably coupled to the support platform (26A). The build bed (28) supports at least a portion of the material (12). The bed mover (28C) rotates the build bed (28) relative to the support platform (26A) in a bed rotation direction (28D) at a second angular velocity. The bed rotation direction (28D) is opposite to the platform rotation direction (30C), and the second angular velocity is one-half the first angular velocity. The energy system (22) directs an energy beam (22B) at the material (12) on the build bed (28) to form at least a portion of the object (11).

### RELATED APPLICATION

This application claims priority on U.S. Provisional Application No. 63/081,214 filed on Sep. 21, 2020, and entitled “ADDITIVE MANUFACTURING SYSTEM HAVING ROTATING SUPPORT PLATFORM WITH INDIVIDUAL ROTATING BUILD BED”. As far as permitted the contents of U.S. Provisional Application No. 63/081,214 are incorporated in their entirety herein by reference.

### BACKGROUND

Three-dimensional printing systems are used to print three-dimensional objects. Existing three-dimensional printing systems are relatively slow, have a low throughput, are expensive to operate, and/or generate excessive waste. As a result thereof, there is a never ending search for at least one of increasing the speed, provide good throughput, and reducing the cost of operation for three-dimensional printing systems.

### SUMMARY

The present implementation is directed to a processing machine for building a three-dimensional object from a material. In various implementations, the processing machine includes a support platform, a platform mover, a build bed, a bed mover, and an energy system. The platform mover rotates the support platform in a platform rotation direction at a first angular velocity. The build bed is movably coupled to the support platform. The build bed supports at least a portion of the material. The bed mover rotates the build bed relative to the support platform in a bed rotation direction at a second angular velocity. The bed rotation direction is opposite to the platform rotation direction, and the second angular velocity is different from, e.g., one-half, the first angular velocity. The energy system directs an energy beam at the material on the build bed to form at least a portion of the object.

In some embodiments, the energy system is configured to direct the energy beam at a first half of the build bed during a first rotation of the support platform. Additionally, in certain such embodiments, the energy system is configured to direct the energy beam at a second half of the build bed during a second rotation of the support platform. Further, in such embodiments, the energy system is configured to illuminate an entire material layer on the build bed during two rotations of the support platform.

In one embodiment, the support platform is substantially flat, disk-shaped. Additionally, in one embodiment, the build bed is also substantially flat, disk-shaped.

In certain embodiments, the platform mover rotates the support platform in the platform rotation direction about a platform rotation axis, and the bed mover rotates the build bed relative to the support platform in the bed rotation direction about a bed rotation axis. In such embodiments, the bed rotation axis can be substantially parallel to and spaced apart from the platform rotation axis.

Additionally, in some embodiments, the energy system includes an energy source that directs the energy beam to illuminate an energy zone on the build bed. In certain such embodiments, the energy source includes a source deflection angle that defines an angular spread of the energy beam. Additionally, in such embodiments, the energy zone is defined at least in part by the source deflection angle and a height of the energy source relative to an upper material layer of the material on the build bed.

Further, in certain embodiments, the bed rotation axis is positioned a build bed distance away from the platform rotation axis, and the build bed has a build bed radius. In some such embodiments, a center of the energy zone is positioned an energy zone distance away from the platform rotation axis that is approximately equal to the build bed distance plus one-half the build bed radius. Alternatively, in other such embodiments, a center of the energy zone is positioned an energy zone distance away from the platform rotation axis that is approximately equal to the build bed distance minus one-half the build bed radius.

Additionally, in some embodiments, the processing machine further includes a vertical bed mover that moves the build bed vertically to maintain the height of the energy source relative to the upper material layer of material on the build bed as successive material layers are added onto the build bed.

Further, in one embodiment, the processing machine further includes a second build bed that is movably coupled to the support platform, the second build bed being positioned spaced apart from the build bed; and a second bed mover that rotates the second build bed relative to the support platform in a second bed rotation direction at the second angular velocity, the second bed rotation direction being opposite to the platform rotation direction, and the second angular velocity being one-half the first angular velocity.

Additionally, the present implementation is further directed toward a processing machine for building a three-dimensional object from a material including a powder bed including a support platform; a platform mover that rotates the support platform in a platform rotation direction at a first angular velocity; a build bed that is movably coupled to the support platform, the build bed supporting at least a portion of the material; a bed mover that rotates the build bed relative to the support platform in a bed rotation direction at a second angular velocity; and an energy system that directs an energy beam at a first part of the build bed during a first rotation of the support platform, and directs the energy beam at a second part of the build bed during a second rotation of the support platform, such that the energy system illuminates a material layer on the build bed during two rotations of the support platform to form at least a portion of the object, wherein the first part is different from the second part.

Further, the present implementation is also directed toward a processing machine for building a three-dimensional object from a material including a support platform; a platform mover that rotates the support platform in a platform rotation direction about a platform rotation axis at a first angular velocity; a build bed that is movably coupled to the support platform, the build bed supporting at least a portion of the material; a bed mover that rotates the build bed relative to the support platform in a bed rotation direction about a bed rotation axis at a second angular velocity, the bed rotation axis being substantially parallel to and positioned spaced apart a build bed distance away from the platform rotation axis; and an energy system that directs an energy beam at the material on the build bed to form at least a portion of the object, the energy system including an energy source that directs the energy beam to illuminate an energy zone on the build bed; and wherein a center of the energy zone is positioned at an off-axis position relative to the bed rotation axis.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified schematic side view illustration of an implementation of a processing machine including a powder bed assembly including a powder bed and one or more build beds having features of the present embodiment;

FIG. 1B is a simplified schematic top view illustration of a portion of the processing machine illustrated in FIG. 1A;

FIG. 2A is a simplified schematic view of representative positions and orientations of the build bed during a first rotation of the powder bed in an implementation of the present embodiment;

FIG. 2B is a simplified schematic view of a representative exposure of the build bed after the first rotation of the powder bed in the implementation of the present embodiment illustrated in FIG. 2A;

FIG. 2C is a simplified schematic view of representative positions and orientations of the build bed during a second rotation of the power bed in the implementation of the present embodiment illustrated in FIG. 2A; and

FIG. 2D is a simplified schematic view of a representative exposure of the build bed after the second rotation of the powder bed in the implementation of the present embodiment illustrated in FIG. 2C.

### DESCRIPTION

Implementations of the present embodiment are described herein in the context of a processing machine such as an additive manufacturing system, e.g., a three-dimensional printer, which utilizes a single energy source or a few energy sources with a relatively small deflection range to provide a cost-efficient three-dimensional printing solution while providing good throughput. Those of ordinary skill in the art will realize that the following detailed description of the present embodiment is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming, but would nevertheless be a routine undertaking of engineering for those of ordinary skill in the art having the benefit of this disclosure.

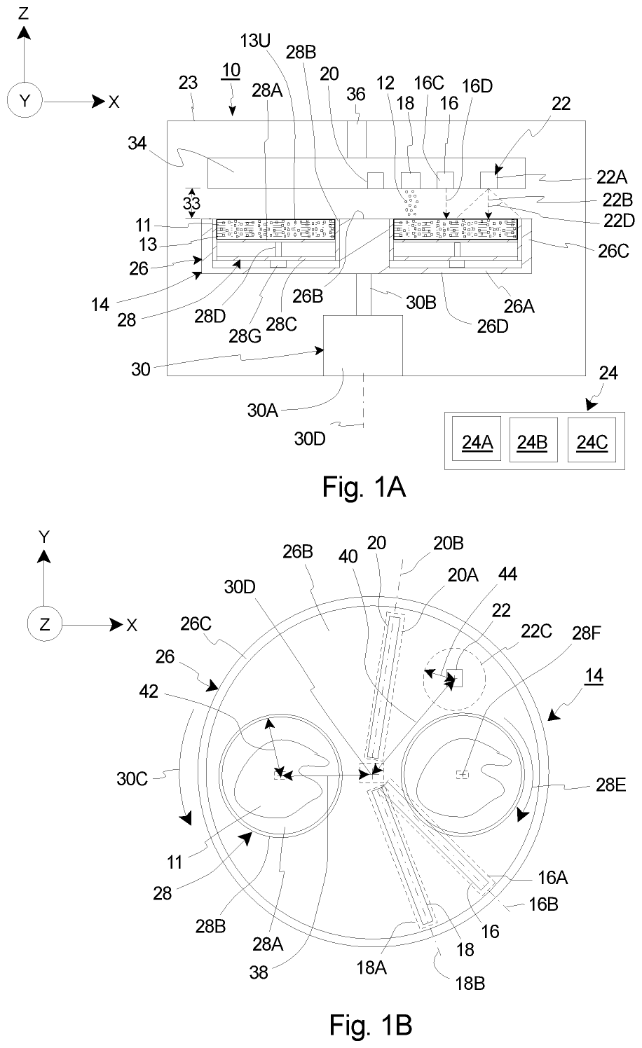

FIG. 1A is a simplified schematic side view illustration of a processing machine 10 that may be used to manufacture one or more three-dimensional objects 11. As provided herein, the processing machine 10 can be an additive manufacturing system, e.g., a three-dimensional printer, in which material 12 (illustrated initially as small circles) is joined, melted, solidified, and/or fused together in a series of material layers 13 (illustrated as dashed horizontal lines) to manufacture one or more three-dimensional object(s) 11 (with the material 12 shown as small squares).

The type of three-dimensional object(s) 11 manufactured with the processing machine 10 may be almost any shape or geometry. As a non-exclusive example, the three-dimensional object 11 may be a metal part, or another type of part, for example, a resin (plastic) part or a ceramic part, etc. The three-dimensional object 11 may also be referred to as a “built part”.

The type of material 12 joined and/or fused together may be varied to suit the desired properties of the object(s) 11. As a non-exclusive example, the material 12 may include metal powder grains (e.g., including one or more of titanium, aluminum, vanadium, chromium, copper, stainless steel, or other suitable metals) or alloys for metal three-dimensional printing. Alternatively, the material 12 may include non-metal powder, plastic, polymer, glass, ceramic powder, organic powder, inorganic powder, or any other material known to people skilled in the art.

A number of different designs of the processing machine 10 are provided herein. In certain implementations, the processing machine 10 includes (i) a material bed assembly 14; (ii) a pre-heat device 16 (illustrated as a box); (iii) a material supply device 18 (illustrated as a box); (iv) a measurement device 20 (illustrated as a box); (v) an energy system 22 (illustrated as a box) including a single energy source 22A that generates an energy beam 22B; and (vi) a control system 24 that cooperate to make each three-dimensional object 11. Additionally, as shown in FIG. 1A, the material bed assembly 14 can include a material bed 26 and one or more build beds 28 (two are shown in FIG. 1A) that are movably (e.g., rotatably) coupled to the material bed 26. The design of each of these components may be varied pursuant to the teachings provided herein. Further, the positions of the components of the processing machine 10 may be different than that illustrated in FIG. 1A. Moreover, the processing machine 10 can include more components or fewer components than illustrated in FIG. 1A. For example, the processing machine 10 can include a cooling device (not shown in FIG. 1A) that uses radiation, conduction, and/or convection to cool the newly melted material 12 to a desired temperature. Alternatively, for example, the processing machine 10 can be designed without the pre-heat device 16 and/or the measurement device 20.

The number of build beds 28 can be varied. For example, in the implementation shown in FIG. 1A, the material bed assembly 14 includes two separate build beds 28, one for each object 11. With this design, a single object 11 is made in each build bed 28. Alternatively, more than one object 11 may be built in each build bed 28. Still alternatively, the material bed assembly 14 can include more than two build beds 28, e.g., three, four, five or six build beds 28, or only one build bed 28.

Additionally, the number of objects 11 that may be made concurrently may vary according the type of object 11 and the design of the processing machine 10. In the non-exclusive embodiment illustrated in FIG. 1A, two objects 11 are made simultaneously. Alternatively, the processing machine 10 can make more than two objects 11, e.g., three, four, five or six objects 11, simultaneously, or only one object 11 may be made at a time.

Further, in one embodiment, each of the objects 11 is the same design. Alternatively, for example, the processing machine 10 may be controlled so that one or more different types of objects 11 are made simultaneously.

As an overview, as described in detail herein below, the problem of a rotating build bed 28 requiring an energy system 22 including multiple energy sources or a single energy source with a large deflection range is solved by rotating the build bed 28 at half of the speed of the material bed 26, in the opposite direction, and locating the energy source 22A of the energy system 22 at an off-axis position relative to a rotational center of the build bed 28. Additionally, the processing machine 10 is also configured to utilize a single energy source 22A with a smaller deflection range than would typically be utilized in order to provide a more cost-effective solution. With such design, the processing machine 10 is able to provide full exposure coverage of the build bed 28, i.e. of the material layers 13 on the build bed 28, with the energy source 22A in two rotations of the material bed 26.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean movement along and about each of the X, Y, and Z axes.

In FIG. 1A, a portion of the material bed assembly 14 is illustrated in cut-away so that the material 12, the material layers 13 and the object 11 are visible. With the present design, one or more objects 11 can be simultaneously made with the processing machine 10. In FIG. 1A, two objects 11 are visible. It is appreciated that in implementations in which multiple objects 11 are made simultaneously with the processing machine 10, these objects 11 can remain separate or they can be joined in subsequently added layers to form a larger object 11.

It should be noted that any of the processing machines 10 described herein may be operated in a controlled environment, e.g., such as a vacuum, using an environmental chamber 23 (illustrated in FIG. 1A as a box). For example, one or more of the components of the processing machine 10 can be positioned entirely or partly within the environmental chamber 23. Alternatively, at least a portion of one or more of the components of the processing machine 10 may be positioned outside the environmental chamber 23. Still alternatively, the processing machine 10 may be operated in non-vacuum environment such as an inert gas (e.g., nitrogen gas or argon gas) environment.

FIG. 1B is a simplified schematic top view illustration of a portion of the material bed assembly 14 of FIG. 1A including the material bed 26 and two build beds 28 that are movably coupled to the material bed 26, and two three-dimensional objects 11, with one three-dimensional objected 11 being formed on each of the build beds 28. FIG. 1B also illustrates (i) the pre-heat device 16 (illustrated as box) and a pre-heat zone 16A (illustrated in phantom) which represents the approximate area in which the material 12 can be pre-heated with the pre-heat device 16; (ii) the material supply device 18 (illustrated as a box) and a deposit zone 18A (illustrated in phantom) which represents the approximate area in which the material 12 can be added and/or spread to the material bed assembly 14 by the material supply device 18; (iii) the measurement device 20 (illustrated as a box) and a measurement zone 20A (illustrated in phantom) which represents the approximate area in which the material 12 and/or the object 11 can be measured by the measurement device 20; and (iv) the energy system 22 (illustrated as a box) and an energy zone 22C (illustrated in phantom) which represents the approximate area in which the material 12 can be melted and fused together by the energy system 22. It should be noted that these zones may be spaced apart differently, oriented differently, or positioned differently from the non-exclusive example illustrated in FIG. 1B. Additionally, the relative sizes of the zones 16A, 18A, 20A, 22C may be different than what is illustrated in FIG. 1B.

Moreover, it should be noted that the processing machine can be designed to include multiple energy systems 22 that are spaced apart or grouped together. Further, each energy system 22 can include one or more energy sources (columns). In the design with multiple energy systems 22, it should be appreciated these energy systems 22 can be positioned wherever appropriate and thus, the energy zones 22C can be located wherever appropriate.

In the implementation illustrated in FIGS. 1A and 1B, the material bed 26 movably supports the one or more build beds 28, the material 12 and the object(s) 11 while the object(s) 11 are being formed. In the simplified schematic illustrated in FIGS. 1A and 1B, the material bed 26 includes a support platform 26A having an upper platform surface 26B, a side support wall 26C, and a lower support wall 26D. In this embodiment, the support platform 26A is generally flat, disk-shaped and includes the upper platform surface 26B that is flat, circular-shaped, the lower support wall 26D is also flat, disk-shaped, and the side support wall 26C is tubular-shaped and extends substantially vertically adjacent a perimeter of the lower support wall 26D.

In another implementation, the support platform 26A is flat, rectangular-shaped, the lower support wall 26D is also flat rectangular-shaped, and the side support wall assembly 26C is rectangular tube-shaped and extends upward from the lower support wall 26D. Alternatively, other shapes of the support platform 26A, the lower support wall 26D and/or side support wall 26C may be utilized. As non-exclusive examples, the support platform 26A and/or the lower support wall 26D can be polygonal-shaped, with the side support wall 26C having a corresponding tubular-shape.

Additionally, as illustrated, the material bed assembly 14 further includes a first platform mover 30 (e.g., one or more actuators) that selectively moves (e.g., rotates) the material bed 26 and/or the support platform 26A. In FIG. 1A, the first platform mover 30 includes a motor 30A (e.g., a rotary motor) and a device connector 30B (e.g., a rigid shaft) that fixedly connects the motor 30A to the material bed 26. In other embodiments, the device connector 30B may include a transmission device such as at least one gear, belt, chain, or friction drive. In this implementation, the first platform mover 30 rotates the material bed 26 in a platform moving (rotation) direction 30C (e.g., counter-clockwise, illustrated by an arrow) about a platform rotation axis 30D (positioned at a rotational center of the material bed 26 and/or the support platform 26A, and illustrated with a “+”, e.g., extending along and/or parallel to the Z axis) relative to one or more of the pre-heat device 16 (and the pre-heat zone 16A), the material supply device 18 (and the deposit zone 18A), the measurement device 20 (and the measurement zone 20A), and the energy system 22 (and the energy zone 22C). This allows nearly all of the rest of the components of the processing machine 10 to be fixed while the material bed 26 and/or the support platform 26A is moved. Additionally, because the material bed 26 is constantly moving, the material 12 may be deposited and fused relatively quickly. This allows for the faster forming of the objects 11, good throughput of the processing machine 10, and reduced cost for the objects 11.

In certain implementations, the first platform mover 30 can move the material bed 26 and/or the support platform 26A at a substantially constant angular velocity in the platform moving direction 30C about the platform rotation axis 30D, e.g., relative to the pre-heat device 16, the material supply device 18, the measurement device 20, and the energy system 22. As alternative, non-exclusive examples, the first platform mover 30 may move the material bed 26 and/or the support platform 26A at a substantially constant angular velocity of at least approximately 0.5, 1, 2, 3, 5, 7, 10, 15, 20, 25, 30, 60, 100 or more revolutions per minute (RPM). Stated in a different fashion, the first platform mover 30 may move the material bed 26 and/or the support platform 26A at a substantially constant angular velocity of between two and one hundred revolutions per minute. As used herein, the term “substantially constant angular velocity” shall mean a velocity that varies less than 10% over time. In one embodiment, the term “substantially constant angular velocity” shall mean a velocity that varies less than 0.2% from a target velocity. The first platform mover 28 may also be referred to as a “drive device”.

Additionally, or alternatively, the first platform mover 30 may move the material bed 26 and/or the support platform 26A at a variable velocity or in a stepped or other fashion. For example, it may be desired to speed up or slow down the rotation of the material bed 26 and/or the support platform 26A for some sections, either as part of a normal cycle like increase time under pre-heater, or as a smart corrective action during the build (e.g., to repair a defect). The platform rotation axis 30D may be aligned along with gravity direction, and may be along with an inclination direction about the gravity direction.

As noted above, the material 12 used to make the object 11 is deposited onto the material bed 26 and/or the build bed(s) 28 in a series of material layers 13. Depending upon the design of the processing machine 10, the material bed assembly 14 with the material 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. The exposure process may be performed during the period when the motion is constant velocity motion.

Further, in some implementations, the support platform 26A can also be moved somewhat similar to a piston relative to the side support wall 26C which acts as the piston's cylinder wall. For example, a second platform mover (e.g., one or more actuators, not shown) can selectively move the support platform 26A downward as each subsequent material layer 13 is added. In certain implementations, the material bed 26 and/or the support platform 26A may be moved down with the second platform mover along the platform rotation axis 30D in a continuous rate via a fine pitch screw or some equivalent method. As provided herein, it is desired to maintain a height 33 between the most recent, upper (top) material layer 13U and the material supply device 18 (and other components) substantially constant for the entire process. In certain embodiments, this can be accomplished by vertical movement of the support platform 26A and/or vertical movement of the build bed 28 relative to the support platform 26A.

In this implementation, only the material bed 26 is primarily moved, while the pre-heat device 16, the material supply device 18, the measurement device 20, and the energy system 22 are all fixed, making the overall system simpler. Also, the throughput of a rotary based material bed 26 system is good since one or more steps can be performed in parallel rather than serially.

In the non-exclusive example in FIG. 1A, the pre-heat device 16, the material supply device 18, the measurement device 20, and the energy system 22 may be fixed together and retained by a common component housing 34. Collectively these components may be referred to as the top assembly. Additionally, in one non-exclusive alternative embodiment, the processing machine 10 can further include a housing mover 36 (e.g., one or more actuators) that can be controlled to selectively move the top assembly. With this design, the common component housing 34 may be rotated along the platform moving direction 30C or an opposite direction of the platform moving direction 30C. Additionally, with such design, it can be desired that the relative rotational movement between the material bed 26 and the top assembly is at a specific desired angular velocity. Still further, and/or alternatively, the housing mover 36 may be configured to move the top assembly (or a portion thereof) upward a continuous (or stepped) rate while the material 12 is being deposited to maintain the desired height 33. It is merely appreciated that in alternative implementations, the relative angular velocity between the material bed 26 and the top assembly is maintained at a desired value, and the desired height 33 between the upper material layer 13U and the top assembly is also maintained.

Additionally, in the implementation illustrated in FIGS. 1A and 1B, the one or more build beds 28 support at least a portion of the material 12 and the object(s) 11 while the object(s) 11 are being formed. More particularly, as provided herein, each of the build beds 28 defines a separate, discrete build region. Additionally, as shown, in certain embodiments, the build bed(s) can be embedded into the material bed 26 such that the build bed 28 is movable relative to the material bed 26 and/or the support platform 26A.

In the simplified schematic illustrated in FIGS. 1A and 1B, each build bed 28 includes a movable bed surface 28A, a bed side wall 28B, and a lower bed wall 28C. In this embodiment, the movable bed surface 28A is flat, disk-shaped, the lower bed wall 28C is flat, disk-shaped, and the bed side wall 28B is tubular-shaped and extends substantially vertically adjacent a perimeter of the upper bed surface 28A and the lower bed wall 28C to provide an open container type design. The bed side wall 28B can be configured so as to prevent unwanted material 12 from falling outside the bed side wall 28B as material 12 is deposited onto the movable bed surface 28A. In alternative embodiments, the material supply device 18 includes features that allow the material 12 distribution to start and stop at appropriate times so that substantially all of the material 12 is deposited inside the build bed 28. In another implementation, the bed side wall 28B can be built concurrently as a custom shape around the object 11, while the object 11 is being built. Still alternatively, the build beds 28 can be configured without the bed side wall 28B. Yet alternatively, the build bed 28 can have another suitable shape, e.g., rectangular or other polygonal shape.

Additionally, as illustrated, each build bed 28 in the material bed assembly 14 further includes a first bed mover 28D (e.g., one or more actuators) that selectively moves the build bed 28 relative to the material bed 26 and/or the support platform 26A. In this implementation, the first bed mover 28D rotates the build bed 28 in a bed rotation direction 28E (e.g., clockwise) about a bed rotation axis 28F (positioned at a rotational center of the build bed 28, and illustrated with a “+”, e.g., along and/or parallel to the Z axis) relative to the material bed 26 and/or the support platform 26A. As illustrated, in various implementations, the bed rotation axis 28F is substantially parallel to and spaced apart from the platform rotation axis 30D. With this design, each build bed 28 can be rotated about two, separate, spaced apart and parallel axes 30D, 28F during the build process.

In certain implementations, the first bed mover 28D can move the build bed 28 at a substantially constant angular velocity in the bed rotation direction 28E about the bed rotation axis 28F, e.g., relative to the material bed 26 and/or the support platform 26A. As alternative, non-exclusive examples, the first bed mover 28D may rotate the build bed 28 at a substantially constant angular velocity of at least approximately 0.25, 0.5, 1, 1.5, 2, 2.5, 5, 7.5, 10, 15, 20, 25, 30, 35, 40, 45 or 50 or more revolutions per minute (RPM). Stated in a different fashion, the first bed mover 28D may move the build bed 28 at a substantially constant angular velocity of between one and fifty revolutions per minute. As used herein, the term “substantially constant angular velocity” may mean a velocity that varies less than 10% over time. In one embodiment, the term “substantially constant angular velocity” may mean a velocity that varies less than 0.2% from a target velocity.

In certain implementations, as noted above, the first platform mover 30 can be configured to rotate the material bed 26 at a platform angular velocity in the platform moving direction 30C about the platform rotation axis 30D (e.g., relative to the top assembly); and the first bed mover 28D can be configured to rotate the build bed 28 in the bed rotation direction 28E about the bed rotation axis 28F, which is opposite to the platform moving direction 30C, at a bed angular velocity that is one-half the platform angular velocity. For example, in one representative implementation, the first platform mover 30 can be configured to rotate the material bed 26 counter-clockwise at a platform angular velocity of approximately two revolutions per minute about the platform rotation axis 30D, and the first bed mover 28D can be configured to rotate the build bed 28 clockwise relative to the material bed 26 and/or the support platform 26A at a bed angular velocity of approximately one revolution per minute about the bed rotation axis 28F.

Additionally, in certain embodiments, the movable bed surface 28A of each build bed 28 can be moved somewhat like an elevator vertically (along the bed rotation axis 28F) relative to its respective bed side wall 28B and the lower bed wall 28C with a second, vertical bed mover 28G (e.g., one or more actuators) during fabrication of the objects 11. In such embodiments, fabrication can begin with the movable bed surface 28A placed near a top of the bed side wall 28B. The material supply device 18 deposits a thin layer of material 12 into each build bed 28 as it is moved (e.g., rotated) below the material supply device 18. At an appropriate time, the movable build surface 28A in each build bed 28 is stepped down via the vertical bed mover 28G by one layer thickness so the next layer of material 12 may be distributed properly.

In certain implementations, the build bed 28 and/or the movable bed surface 28A may be moved down with the vertical bed mover 28G along the bed rotation axis 28F in a continuous rate via a fine pitch screw or some equivalent method. With such design, the height 33 between the most recent, upper (top) material layer 13U and the material supply device 18 (and other components) may be maintained substantially constant for the entire process. Alternatively, the build bed 28 and/or the movable bed surface 28A may be moved down in a step down fashion at each rotation, which could lead to the possibility of a discontinuity at one radial position in the build bed 28. As used herein, “substantially constant” shall mean the height 33 varies by less than a factor of three, since the typical thickness of each material layer is less than one millimeter. In another embodiment, “substantially constant” may mean the height 33 varies less than ten percent of the height 33 during the manufacturing process.

The pre-heat device 16 selectively preheats the material 12 in the pre-heat zone 16A that has been deposited on the build bed 28 during a pre-heat time. In certain embodiments, the pre-heat device 16 heats the material 12 to a desired preheated temperature in the pre-heat zone 16A when the material 12 is moved through the pre-heat zone 16A. The number of the pre-heat devices 16 may be one or plural.

In one embodiment, the pre-heat device 16 is positioned along a pre-heat axis (direction) 16B. Additionally, in certain alternative implementations, the pre-heat device 16 can be positioned in any suitable manner relative to the material supply device 18, the measurement device 20 and the energy system 22.

The design of the pre-heat device 16 and the desired preheated temperature may be varied. In one embodiment, the pre-heat device 16 may include one or more pre-heat energy source(s) 16C that direct one or more pre-heat beam(s) 16D at the material 12. Each pre-heat beam 16D may be steered as necessary. As alternative, non-exclusives examples, each pre-heat energy source 16C may be an electron beam system, a mercury lamp, an infrared laser, a supply of heated air, thermal radiation system, a visual wavelength optical system or a microwave optical system. The desired preheated temperature may be 50% 75% 90% or 95% of the melting temperature of the material used in the printing.

It is understood that different materials have different melting points and therefore different desired pre-heating points. As non-exclusive examples, the desired melting temperature of the material 12 may be at least 1000, 1400, 1700, 2000, or more degrees Celsius. Thus, in such non-exclusive examples, the desired preheated temperature may be at least 300, 500, 700, 900, or 1000 degrees Celsius. Energy input may also vary dependent on melt duty of previous layers, specific regions on a layer, or progress though the build.

Additionally, it is further appreciated that the timing of the preheating of the material 12 with the pre-heat device 16 and/or the pre-heat energy source(s) 16C can be varied. For example, in one implementation, the pre-heat device 16 and/or the pre-heat energy source(s) 16C are used to preheat the material 12 once for every two rotations of the material bed 26 and/or the support platform 26A. Alternatively, in another implementation, the pre-heat device 16 and/or the pre-heat energy source(s) 16C are used to preheat the material 12 for every rotation of the material bed 26 and/or the support platform 26A.

The material supply device 18 deposits the material 12 onto the build bed(s) 28 and/or the movable bed surface 28A during a material deposition time to sequentially form each material layer 13. With the present design, the material supply device 18 sequentially forms individual material layers 13 on top of the movable bed surface 28A of the build bed(s) 28. In certain embodiments, the material supply device 18 supplies the material 12 to the build bed(s) 28 in the deposit zone 18A while the material bed 26 and the build bed(s) 28 are being moved to form each material layer 13.

In one implementation, the material supply device 18 extends along a material supply axis (direction) 18B. Additionally, in certain alternative implementations, the material supply device 18 can be positioned in any suitable manner relative to pre-heat device 16, the measurement device 20 and the energy system 22. The material supply device 18 can include one or more material containers (not shown in FIGS. 1A and 1B). The number of the material supply devices 18 may be one or plural.

With the present design, the material supply device 18 deposits the material 12 onto the material bed assembly 14 to sequentially form each material layer 13. Once a portion of the material layer 13 has been melted with the energy system 22, the material supply device 18 evenly and uniformly deposits another (subsequent) material layer 13.

In the non-exclusive embodiment in FIG. 1A, the material supply device 18 is a single overhead material supply that supplies the material 12 onto the movable bed surface 28A of the individual build bed(s) 28. In this design, the material supply device 18 can include a rake (not shown) or other device that distributes/levels each sequential material layer 13. In one non-exclusive implementation, the material supply device 18, including the rake, can be configured to distribute/level each sequential material layer 13 once for every two rotations of the material bed 26 and/or the support platform 26A. Alternatively, the material supply device 18 can be designed to include multiple material supplies (at different locations) and/or other ways to distribute/level each sequential material layer 13. Still alternatively, in each of the processing machines 10 disclosed herein, the material supply device 18 can be a table-integrated material supply (not shown) which delivers the material 12 from the side or through the material bed assembly 14, or another type of material supply device.

It should be noted that the three-dimensional object 11 is formed through consecutive fusions of consecutively formed cross-sections of material 12 in one or more material layers 13. For simplicity, the example of FIG. 1A illustrates only a few, separate, stacked material layers 13. However, it should be noted that depending upon the design of the object 11, the building process will require numerous material layers 13.

The measurement device 20 inspects and monitors the melted (fused) layers of the object 11 in the measurement zone 20A during a measurement time as the object 11 is being built, and/or during the deposition of the material layers 13. The number of the measurement devices 20 may be one or plural. For example, the measurement device 20 can measure both before and after the material 12 is distributed. Additionally, the measurement device 20 may inspect the material layer(s) 13 or the built part 11 optically, electrically, or physically.

As non-exclusive examples, the measurement device 20 may include one or more optical elements such as a uniform illumination device, fringe illumination device (structured illumination device), cameras that function at one or more wavelengths, lens, interferometer, or photodetector, or a non-optical measurement device such as an ultrasonic, eddy current, or capacitive sensor.

Additionally, in certain alternative implementations, the measurement device 20 can be positioned in any suitable manner relative to the pre-heat device 16, the material supply device 18 and the energy system 22.

The energy system 22 selectively heats and melts the material 12 in the energy zone 22B during a melting time to sequentially form each of the layers of the object 11 while the material bed 26, the build bed(s) 28, and the object 11 are being moved. The energy system 22 can selectively melt the material 12 at least based on a data regarding to the object 11 to be built. The data may be corresponding to a computer-aided design (CAD) model data.

As described in detail herein, in various implementations, the processing machine 10 is configured to include only a single energy system 22, e.g., a single energy source 22A, that directs the energy beam 22B at the material 12. The energy source 22A can be controlled to steer the energy beam 22B to melt the material 12. Alternatively, in other implementations, the processing machine 10 may include more than one energy system 22.

In one implementation, the energy source 22A can be configured to direct the energy beam 22B with a limited, source deflection angle 22D to illuminate the energy zone 22C. It is appreciated that the source deflection angle 22D in conjunction with the height 33 of the energy source 22A relative to the upper material layer 13U (or top material layer) effectively define the energy zone 22C.

The energy source 22A and thus the defined energy zone 22C can be positioned in any suitable manner relative to the build bed(s) 28. In one implementation, the rotational center (or bed rotation axis 28F) of the build bed 28 is positioned a build bed distance 38 away from the rotational center (or platform rotation axis 30D) of the material bed 26; and the center of the energy zone 22C, as defined by the chief (or center) ray of the energy beam 22B, is positioned an energy zone distance 40 away from the center (or platform rotation axis 30D) of the material bed 26 that is approximately equal to the build bed distance 38 plus or minus one-half a build bed radius 42. For example, in one representative embodiment, the build bed distance 38 is approximately 150 mm from the rotational center (or platform rotation axis 30D) of the material bed 26, and the build bed radius 42 is approximately 75 mm. In such embodiment, the energy source 22A can be positioned such that the energy zone distance 40 is approximately (150 mm+75/2 mm=187.5 mm) away from the rotational center (or platform rotation axis 30D) of the material bed 26, or the energy source 22A can be positioned so that the energy zone distance 40 is approximately (150 mm−75/2 mm=112.5 mm) away from the rotational center (or platform rotation axis 30D) of the material bed 26. The center of the energy zone 22C may be considered as an (optical) axis of the energy system 22.

Additionally, the energy zone 22C, as defined by the height 33 and the source deflection angle 28D, can have an energy zone radius 44 of at least approximately one-half the build bed radius 42, or at least approximately 37.5 mm in the above example. As utilized herein, the energy zone radius 44 being at least approximately one-half the build bed radius 42 is intended to signify that the energy zone radius is no more than 0.1%, 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5% or 10.0% greater than the build bed radius 42.

As alternative, non-exclusives examples, the energy source 22A can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different materials 12 have different melting points. As non-exclusive examples, the desired melting temperature may be at least 1000, 1400, 1700, 2000, or more degrees Celsius.

As alternative, non-exclusives examples, each of the energy sources 22C may be an electron beam system that generates a charged particle beam, a laser beam system that generates a laser beam, an electron beam, an ion beam system that generates a charged particle beam, or an electric discharge arc, and the desired irradiation temperature may be at least 1000, 1400, 1700, 2000, or more degrees Celsius. In another embodiment, each of the irradiation energy sources 22C may be designed to generate a charged particle beam, an infrared light beam, a visual beam or a microwave beam, and the desired irradiation temperature may be at least 50% 75% 90% or 95% of the melting temperature of the material used in the printing. It is understood that different materials have different melting points and therefore different desired pre-heating points. The irradiation energy sources 22C can be a laser beam system that generates a laser beam.

It should be noted that with the design provided herein, multiple operations may be performed at the same time (simultaneously) to provide good throughput for the processing machine 10. Stated in another fashion, one or more of the pre-heat time, the material deposition time, the measurement time, and the melting time may be partly or fully overlapping in time for any given processing of a layer 13 of material 12 to provide good throughput for the processing machine 10. For example, two, three, or all four of these times may be partly or fully overlapping. More specifically, (i) the pre-heat time may be at least partly overlapping with the material deposition time, the measurement time, and/or the melting time; (ii) the material deposition time may be at least partly overlapping with the pre-heat time, the measurement time, and/or the melting time; (iii) the measurement time may be at least partly overlapping with the material deposition time, the pre-heat time, and/or the melting time; and/or (iv) the melting time may be at least partly overlapping with the material deposition time, the measurement time, and/or the pre-heat time.

The control system 24 controls the components of the processing machine 10 to build the three-dimensional object 11 from the computer-aided design (CAD) model by successively melting portions of one or more of the material layers 13. For example, the control system 24 can control (i) the material bed assembly 14; (ii) the pre-heat device 16; (iii) the material supply device 18; (iii) the measurement device 20; and (iv) the energy system 22. The control system 24 can be a distributed system.

The control system 24 may include, for example, a CPU (Central Processing Unit) 24A, a GPU (Graphics Processing Unit) 24B, and electronic memory 24C. The control system 24 functions as a device that controls the operation of the processing machine 10 by the CPU 24A executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU 24A may be recorded in a memory (that is, a recording medium) included in the control system 24, or an arbitrary storage medium built in the control system 24 or externally attachable to the control system 24, for example, a hard disk or a semiconductor memory. Alternatively, the CPU 24A may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications line (cable communications), a wireless communications line, or a network. In case of physically connecting with a wired communications line, it is possible to use serial connection or parallel connection of IEEE1394, RS-232x, RS-422, RS-423, RS-485, USB, etc. or 10BASE-T, 100BASE-TX, 1000BASE-T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

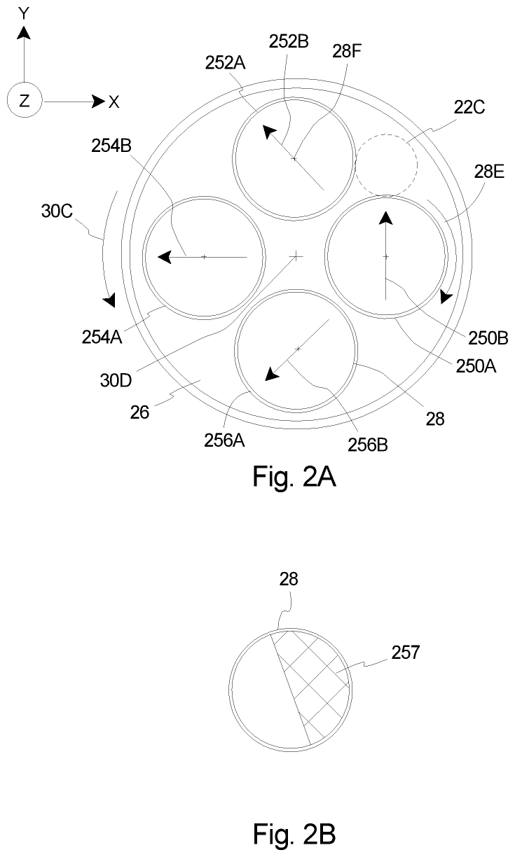

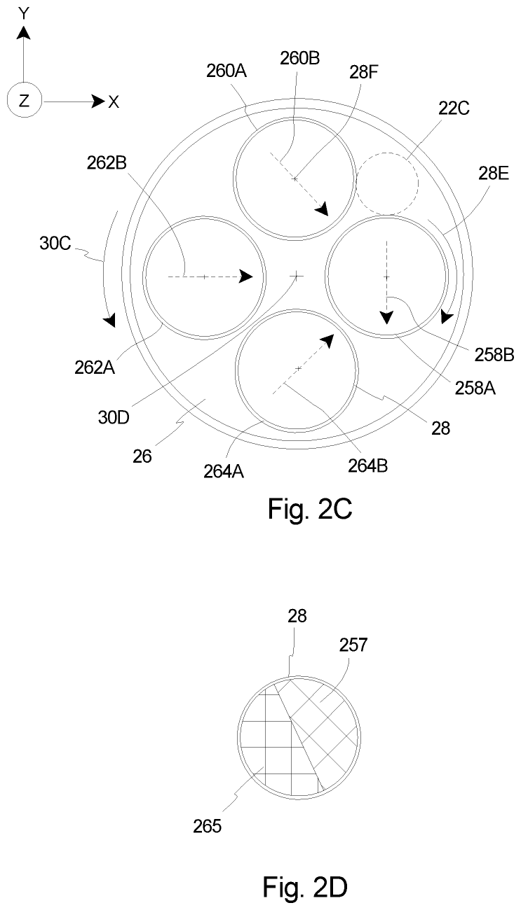

FIG. 2A is a simplified schematic view of representative positions and orientations of the build bed 28 during a first rotation of the material bed 26 in an implementation of the present embodiment. In the implementation illustrated in FIG. 2A, the material bed 26 is being rotated relative to the top assembly (illustrated in FIG. 1A) in the platform moving direction 30C (illustrated with an arrow), i.e. counter-clockwise, about the platform rotation axis 30D at a material bed angular velocity, and the build bed 28 is being rotated relative to the material bed 26 in the bed rotation direction 28E (illustrated with an arrow), i.e. clockwise, about the bed rotation axis 28F at a build bed angular velocity that is one-half the material bed angular velocity (and in the opposite direction).

More particularly, as illustrated, the build bed 28 is alternatively shown at a first position 250A, at time t₀, a second position 252A, at time t₁, a third position 254A, at time t₂, and a fourth position 256A, at time t₃, during the first rotation of the material bed 26. Additionally, FIG. 2A further illustrates the orientation of the build bed 28 relative to the material bed 26 at such times during the first rotation of the material bed 26. More specifically, the build bed 28 is shown to be in a first orientation 250B (illustrated with an arrow) relative to the material bed 26 when at the first position 250A, at time t₀; in a second orientation 252B (illustrated with an arrow) relative to the material bed 26 when at the second position 252A, at time t₁; in a third orientation 254B (illustrated with an arrow) relative to the material bed 26 when at the third position 254A, at time t₂; and in a fourth orientation 256B (illustrated with an arrow) relative to the material bed 26 when at the fourth position 256A, at time t₃.

Further illustrated in FIG. 2A is an implementation of the energy zone 22C (illustrated in phantom), which, as described above, is defined by the source deflection angle 22D (illustrated in FIG. 1A) and the height 33 (illustrated in FIG. 1A) of the energy source 22A (illustrated in FIG. 1A) relative to the upper material layer 13U (illustrated in FIG. 1A), and which represents the approximate area in which the material 12 (illustrated in FIG. 1A) can be melted and fused together by the energy system 22 (illustrated in FIG. 1A).

FIG. 2B is a simplified schematic view of a representative exposure of the build bed 28 after the first rotation of the material bed 26 (illustrated in FIG. 2A) in the implementation of the present embodiment illustrated in FIG. 2A. It is appreciated that the representative exposure of the build bed 28 after the first rotation of the material bed 26 as illustrated in FIG. 2B is based on the positioning and design of the energy system 22 (illustrated in FIG. 1A) and the energy source 22A (illustrated in FIG. 1A), and the size and positioning of the energy zone 22C (illustrated in FIG. 2A) such as described herein above.

In particular, as shown in FIG. 2B, after the first rotation of the material bed 26, and with the energy system 22, energy source 22A, and energy zone 22C positioned and designed as described above, a first exposed area 257 equal to one-half of the build bed 28 has been exposed. Thus, after the first rotation of the material bed 26, one-half of the upper material layer 13U (illustrated in FIG. 1A) has been exposed and melted as desired.

FIG. 2C is a simplified schematic view of representative positions and orientations of the build bed 28 during a second rotation of the power bed 26 in the implementation of the present embodiment illustrated in FIG. 2A. In the implementation illustrated in FIG. 2C, the material bed 26 is still being rotated relative to the top assembly (illustrated in FIG. 1A) in the platform moving direction 30C (illustrated with an arrow), i.e. counter-clockwise, about the platform rotation axis 30D at the material bed angular velocity, and the build bed 28 is still being rotated relative to the material bed 26 in the bed rotation direction 28E (illustrated with an arrow), i.e. clockwise, about the bed rotation axis 28F at the build bed angular velocity that is one-half the material bed angular velocity (and in the opposite direction).

More particularly, as illustrated, the build bed 28 is alternatively shown at a fifth position 258A, at time t₄, a sixth position 260A, at time t₅, a seventh position 262A, at time t₆, and an eighth position 264A, at time t₇, during the second rotation of the material bed 26. Additionally, FIG. 2C further illustrates the orientation of the build bed 28 relative to the material bed 26 at such times during the second rotation of the material bed 26. More specifically, the build bed 28 is shown to be in a fifth orientation 258B (illustrated with a dashed arrow) relative to the material bed 26 when at the fifth position 258A, at time t₄; in a sixth orientation 260B (illustrated with a dashed arrow arrow) relative to the material bed 26 when at the sixth position 260A, at time t₅; in a seventh orientation 262B (illustrated with a dashed arrow) relative to the material bed 26 when at the seventh position 262A, at time t₆; and in an eighth orientation 264B (illustrated with a dashed arrow) relative to the material bed 26 when at the eighth position 264A, at time t₇.

It is appreciated that at the end of the second rotation of the material bed 26, the build bed 28 will have returned to the same position and orientation that the build bed 28 had relative to the material bed 26 prior to and/or at the start of the first rotation of the material bed 26.

Further illustrated in FIG. 2C is the same implementation of the energy zone 22C (illustrated in phantom), such as is shown in FIG. 2A.

FIG. 2D is a simplified schematic view of a representative exposure of the build bed 28 after the second rotation of the material bed 26 (illustrated in FIG. 2A) in the implementation of the present embodiment illustrated in FIG. 2C. It is appreciated that the representative exposure of the build bed 28 after the second rotation of the material bed 26 as illustrated in FIG. 2D is again based on the positioning and design of the energy system 22 (illustrated in FIG. 1A) and the energy source 22A (illustrated in FIG. 1A), and the size and positioning of the energy zone 22C (illustrated in FIG. 2A) such as described herein above.

In particular, as shown in FIG. 2D, after the second rotation of the material bed 26, and with the energy system 22, energy source 22A, and energy zone 22C positioned and designed as described above, a second exposed area 265 equal to one-half of the build bed 28 has been exposed, in addition to the first exposed area 257 equal to one-half of the build bed 28 that was exposed during the first rotation of the material bed 26. Thus, after the second rotation of the material bed 26, an entirety of the upper material layer 13U (illustrated in FIG. 1A) has been exposed and melted as desired, with a different half of the build bed 28 having been exposed during each of the first rotation and the second rotation of the material bed 26.

It is appreciated that such methodology can be repeated as often as necessary to ultimately provide the final object 11 (illustrated in FIG. 1A) with as many material layers 13 (illustrated in FIG. 1A) as desired, with each material layer 13 being exposed and melted as desired during each two rotations of the material bed 26. Moreover, it is further appreciated that a new material layer 13 is deposited onto the build bed 28, i.e. by the material supply device 18 (illustrated in FIG. 1A) after each two rotations of the material bed 26.

It is understood that although a number of different embodiments of the processing machine have been illustrated and described herein, one or more features of any one embodiment can be combined with one or more features of one or more of the other embodiments, provided that such combination satisfies the intent of the present invention. While a number of exemplary aspects and embodiments of the processing machine have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope, and no limitations are intended to the details of construction or design herein shown.

What is claimed is:

1. A processing machine for building an object from a material, the processing machine comprising:
a support platform;
a platform mover that rotates the support platform in a platform rotation direction at a first angular velocity;
a build bed that is movably coupled to the support platform, the build bed supporting at least a portion of the material;
a bed mover that rotates the build bed relative to the support platform in a bed rotation direction at a second angular velocity, the bed rotation direction being opposite to the platform rotation direction, and the second angular velocity being different from the first angular velocity; and
an energy system that directs an energy beam at the material on the build bed to form at least a portion of the object.

2. The processing machine of claim 1, wherein the second angular velocity is approximately one-half the first angular velocity.

3. The processing machine of claim 1, wherein the energy system is configured to direct the energy beam at a first half of the build bed during a first rotation of the support platform.

4. The processing machine of claim 3, wherein the energy system is configured to direct the energy beam at a second half of the build bed during a second rotation of the support platform.

5. The processing machine of claim 1, wherein the energy system is configured to illuminate an entire material layer on the build bed during two rotations of the support platform.

6. The processing machine of claim 1, wherein the support platform is substantially flat, disk-shaped.

7. The processing machine of claim 1, wherein the build bed is substantially flat, disk-shaped.

8. The processing machine of claim 1, wherein the platform mover rotates the support platform in the platform rotation direction about a platform rotation axis; wherein the bed mover rotates the build bed relative to the support platform in the bed rotation direction about a bed rotation axis; and wherein the bed rotation axis is substantially parallel to and spaced apart from the platform rotation axis.

9. The processing machine of claim 8, wherein the energy system includes an energy source that directs the energy beam to illuminate an energy zone on the build bed.

10. The processing machine of claim 9, wherein the energy source includes a source deflection angle that defines an angular spread of the energy beam; and wherein the energy zone is defined at least in part by the source deflection angle and a height of the energy source relative to an upper material layer of the material on the build bed.

11. The processing machine of claim 9, wherein the bed rotation axis is positioned a build bed distance away from the platform rotation axis; wherein the build bed has a build bed radius; and wherein a center of the energy zone is positioned an energy zone distance away from the platform rotation axis that is approximately equal to the build bed distance plus one-half the build bed radius.

12. The processing machine of claim 9, wherein the bed rotation axis is positioned a build bed distance away from the platform rotation axis; wherein the build bed has a build bed radius; and wherein a center of the energy zone is positioned an energy zone distance away from the platform rotation axis that is approximately equal to the build bed distance minus one-half the build bed radius.

13. The processing machine of claim 12, further comprising a vertical bed mover that moves the build bed vertically to maintain the height of the energy source relative to the upper material layer of material on the build bed as successive material layers are added onto the build bed.

14. The processing machine of claim 1, further comprising a second build bed that is movably coupled to the support platform, the second build bed being positioned spaced apart from the build bed; and a second bed mover that rotates the second build bed relative to the support platform in a second bed rotation direction at the second angular velocity, the second bed rotation direction being opposite to the platform rotation direction, and the second angular velocity being one-half the first angular velocity.

15. A processing machine for building an object from a material, the processing machine comprising:
a support platform;
a platform mover that rotates the support platform in a platform rotation direction at a first angular velocity;
a build bed that is movably coupled to the support platform, the build bed supporting at least a portion of the material;
a bed mover that rotates the build bed relative to the support platform in a bed rotation direction at a second angular velocity; and
an energy system that directs an energy beam at a first part of the build bed during a first rotation of the support platform, and directs the energy beam at a second part of the build bed during a second rotation of the support platform, such that the energy system illuminates a material layer on the build bed during two rotations of the support platform to form at least a portion of the object, wherein the first part is different from the second part.

16. The processing machine of claim 15, wherein the first part of the build bed includes a first half of the build bed, and wherein the second part of the build bed includes a second half of the build bed.

17. The processing machine of claim 15, wherein the bed rotation direction is opposite to the platform rotation direction.

18. The processing machine of claim 15, wherein the second angular velocity is one-half the first angular velocity.

19. The processing machine of claim 15, wherein the support platform is substantially flat, disk-shaped.

20. The processing machine of claim 15, wherein the build bed is substantially flat, disk-shaped.

21. The processing machine of claim 15, wherein the platform mover rotates the support platform in the platform rotation direction about a platform rotation axis; wherein the bed mover rotates the build bed relative to the support platform in the bed rotation direction about a bed rotation axis; and wherein the bed rotation axis is substantially parallel to and spaced apart from the platform rotation axis.

22. The processing machine of claim 15, wherein the energy system includes an energy source that directs the energy beam to illuminate an energy zone on the build bed.

23. The processing machine of claim 22, wherein the energy source includes a source deflection angle that defines an angular spread of the energy beam; and wherein the energy zone is defined at least in part by the source deflection angle and a height of the energy source relative to an upper material layer of the material on the build bed.

24. The processing machine of claim 22, wherein the bed rotation axis is positioned a build bed distance away from the platform rotation axis; wherein the build bed has a build bed radius; and wherein a center of the energy zone is positioned an energy zone distance away from the platform rotation axis that is approximately equal to the build bed distance plus one-half the build bed radius.

25. The processing machine of claim 22, wherein the bed rotation axis is positioned a build bed distance away from the platform rotation axis; wherein the build bed has a build bed radius; and wherein a center of the energy zone is positioned an energy zone distance away from the platform rotation axis that is approximately equal to the build bed distance minus one-half the build bed radius.

26. The processing machine of claim 25, further comprising a vertical bed mover that moves the build bed vertically to maintain the height of the energy source relative to the upper material layer of material on the build bed as successive material layers are added onto the build bed.

27. The processing machine of claim 26, further comprising a second build bed that is movably coupled to the support platform, the second build bed being positioned spaced apart from the build bed; and a second bed mover that rotates the second build bed relative to the support platform in a second bed rotation direction at the second angular velocity.

28. A processing machine for building an object from a material, the processing machine comprising:
a support platform;
a platform mover that rotates the support platform in a platform rotation direction about a platform rotation axis at a first angular velocity;
a build bed that is movably coupled to the support platform, the build bed supporting at least a portion of the material;
a bed mover that rotates the build bed relative to the support platform in a bed rotation direction about a bed rotation axis at a second angular velocity, the bed rotation axis being substantially parallel to and positioned spaced apart a build bed distance away from the platform rotation axis; and
an energy system that directs an energy beam at the material on the build bed to form at least a portion of the object, the energy system including an energy source that directs the energy beam to illuminate an energy zone on the build bed; and
wherein a center of the energy zone is positioned at an off-axis position relative to the bed rotation axis.

29. The processing machine of claim 28, wherein the build bed includes a build bed radius, and a center of the energy zone is positioned an energy zone distance away from the platform rotation axis that is approximately equal to one of the build bed distance plus one-half the build bed radius, and the build bed distance minus one-half the build bed radius.

30. The processing machine of claim 28, wherein the bed rotation direction is opposite to the platform rotation direction.

31. The processing machine of claim 28, wherein the second angular velocity is one-half the first angular velocity.

32. The processing machine of claim 28, wherein the energy system directs the energy beam at a first half of the build bed during a first rotation of the support platform.

33. The processing machine of claim 28, wherein the energy system directs the energy beam at a second half of the build bed during a second rotation of the support platform.

34. The processing machine of claim 28, wherein the energy system illuminates an entire material layer on the build bed during two rotations of the support platform.

35. The processing machine of claim 28, wherein the support platform is substantially flat, disk-shaped.

36. The processing machine of claim 28, wherein the build bed is substantially flat, disk-shaped.

37. The processing machine of claim 28, wherein the energy source includes a source deflection angle that defines an angular spread of the energy beam; and wherein the energy zone is defined at least in part by the source deflection angle and a height of the energy source relative to an upper material layer of the material on the build bed.

38. The processing machine of claim 37, further comprising a vertical bed mover that moves the build bed vertically to maintain the height of the energy source relative to the upper material layer of material on the build bed as successive material layers are added onto the build bed.

39. The processing machine of claim 28, further comprising a second build bed that is movably coupled to the support platform, the second build bed being positioned spaced apart from the build bed; and a second bed mover that rotates the second build bed relative to the support platform in a second bed rotation direction at the second angular velocity.
